(19) United States
(12) Patent Application Publication
(10) Pub. No.: US 2010/0205604 A1
(43) Pub. Date: Aug. 12, 2010

(54) SYSTEMS AND METHODS FOR EFFICIENTLY RUNNING MULTIPLE INSTANCES OF MULTIPLE APPLICATIONS

(75) Inventors: Eric T. Brower, Sunnyvale, CA (US); Jonathan Lundell, Half Moon Bay, CA (US); Eric L. Green, Santa Clara, CA (US)

Correspondence Address: KNOBBE MARTENS OLSON & BEAR LLP, 2040 MAIN STREET, FOURTEENTH FLOOR, IRVINE, CA, 92614, US

(73) Assignee: Resilience Corporation, Mountain View, CA (US)

(21) Appl. No.: 12/368,123

(22) Filed: Feb. 9, 2009

(51) Int. Cl. G06F 9/46

(52) U.S. Cl. 718/102

(57) ABSTRACT

A system and method for managing multiple instances of a software application running on a single operating system is described. The system may be a server which hosts multiple copies of the same software application running in real time within a framework. The framework prevents the multiple copies of the application from interfering with one another.

### BACKGROUND OF THE INVENTION

1. Field of the invention

This invention relates to systems and methods for simultaneously running multiple instances of multiple computer software applications. More particularly, the invention relates to a computer architecture and operating method that allows software applications not designed to run multiple times without conflict on a computer system to have multiple simultaneous accesses to conflicting resources of a computer system without modifying the software applications.

2. Description of the related art

A computer system can be regarded as a “stack” of resources that provide a hardware and operating system software environment in which application software runs. In the simplest version, application software runs on top of an operating system (OS), which runs on computer hardware. The operating system provides access to the various resources including input/output (IO) features of the hardware, access to permanent or temporary storage organized in a file system, and performs scheduling of tasks or processes to individual CPUs or cores for execution.

In certain circumstances, an application will need to access various hardware resources, such as IO devices, or portions of the storage system (e.g. hard drive) of the computer system. In doing so, a particular application when utilizing these hardware resources, will prevent other applications from using the resources, or will change the resources such that another application will not receive the resource in a condition it expects. This may happen when a single application is executed twice on a single computer system. A typical application is programmed to access specific IO devices and read/write data in specific areas of the file system. Hardware virtualization is one technique that has been used to allow multiple applications to run with their own virtual set of resources, such that they do not conflict with other applications trying to use similar resources.

Hardware virtualization creates one or more virtual versions of this stack. However, virtualization architectures vary considerably. For example, the virtual CPU hardware can be emulated in software, or the virtualized stack can run directly on the host CPU as part of a guest system.

In general, the guest system interacts with actual physical resources, which implies access to IO features of the hardware. This access is mediated in a variety of ways; typically, IO drivers in the guest operating system software cooperate with a virtualization layer in the host system software to provide virtualized access to IO resources such as data storage, operator communication, and networks.

The guest's operating system software can be independent of the host's (e.g. Windows guest on Linux host), or it can be constrained to be the same as the host's.

Hardware virtualization accomplishes the goal of hardware consolidation, but with several significant drawbacks. For example, each service instance normally requires its own running copy of the entire operating system with its own life cycle and administrative/management overhead. This can lead to high administrative costs when running dozens or hundreds of service instances on a system.

Normally, each service instance also requires its own file system(s), again with their own life cycle and administrative/management overhead. Moreover, virtualized disk (file) IO requires significant overhead, resulting in lower performance and inefficient use of system resources. Consider the following example relating to disk IO in a system with hardware virtualization:

Application requests data from guest OS;

Guest OS requests data from virtualization layer (hypervisor);

Hypervisor requests data from host OS;

Host OS reads data from disk;

Host OS returns data to hypervisor;

Hypervisor returns data to guest OS;

Guest OS returns data to application.

In addition to disk IO, systems using hardware virtualization also struggle with Network IO management, which can require significant extra overhead, resulting in lower performance and inefficient use of system resources. Consider the following example:

Network hardware passes incoming packet to host OS;

Host OS passes packet to hypervisor;

Hypervisor passes packet to guest OS;

Guest OS passes packet to application.

The separation of the guest OS from the hypervisor from the host OS can be useful in some cases (for example, when the guest OS is different from host OS), but imposes needless overhead when running a plurality of network-services within a homogeneous operating environment.

OS virtualization (zones, containers, etc) is another approach to virtualization that tries to address some of these problems by giving up some of the generality of full hardware virtualization. In OS virtualization, the virtual (guest) environment operates as a clone of the host environment in its entirety.

### BRIEF DESCRIPTION OF THE DRAWINGS

FIG. 1 is a block diagram of a system for running multiple instances of an application.

FIG. 2 is a block diagram of various states of execution of the helper application for generating an instance of an application with its own private context.

FIG. 3 is a representation of a file system as used by the system of FIG. 1 implemented as a nested tree.

FIG. 4 is a stack of resources utilized by the system for running multiple instances of an application.

FIG. 5 is the stack of resources utilized by the system over time for generating and running multiple instances of an application.

FIG. 6 is the system of FIG. 1 further connected to various devices to receive commands to control or modify the system for running multiple instances of an application.

FIG. 7 is a process for generating an uninitialized template file.

FIG. 8 is a process for executing the system for running multiple instances of an application.

FIG. 9 is a process for creating file location associations between the global file system namespace and the private file system namespace (remapping) of the file system of FIG. 3.

### DETAILED DESCRIPTION

The following detailed description is directed to certain specific embodiments. However, the teachings herein can be applied in a multitude of different ways. In this description, reference is made to the drawings wherein like parts are designated with like numerals throughout.

Many computer applications or software programs are not designed to run as multiple instances, versions, or copies on a given computer. Such applications may not fully utilize the resources of the computer system such as use of multiple processors. Some embodiments of the invention related to methods and devices, are described herein, which are configured to run multiple instances of such an application without modification on a computer. These devices may comprise programmable computer systems or the like capable of running multiple instances of an application on a computer. These devices can be used for a variety of applications including running multiple instances of an application on a single server for clients.

Methods and devices are described herein for running multiple copies of an application not designed for running as multiple instances on a computing device, such as a computer server, without modification of the application. For example, in one embodiment, these devices are configured to run multiple instances of an Internet Protocol (IP) traffic monitoring application on a single server, each application instance having its own “context” in which to run. This allows a single server to run an instance of the monitoring application for each individual computer connected to the single server without conflict, without modification of the application, and without requiring each individual computer to run the application itself As used herein a “context” is the virtual environment or set of data and resources that an application uses when running.

As described below, embodiments of the invention run multiple copies of unmodified software applications not designed to run multiple instances on a single computing device without conflict. In one embodiment an application is chosen to be run multiple times, such as an IP monitoring application not designed to run multiple instances on a given computing device. When normally running such an application unmodified, various resources of the computing device are utilized. For example, an IP monitoring application may search through files received over a network connection looking for viruses or traffic patterns and in the process log the results of the search in a log file, which may be located on the storage of the computing device. Further, the IP monitoring application may reference certain definition files, which define the viruses or patterns to be searched for. The IP monitoring application may not change the definition files each time it is run, but rather just references the definition files. However, each time the IP monitoring application is run it will create a new log file detailing the search conducted by that particular instance of the IP monitoring application. In this case, running the IP monitoring application multiple times might create a conflict in the log file as both instances would attempt to write to the log file at the same time regarding different searches. Conflicts may be identified either manually or automatically for each application. For example, an individual may use a computer to monitor how an IP monitoring application accesses the various resources of the computer and log which resources are used and how they are used by the application. This information is used to create the virtualization system described herein so that the multiple copies of the unmodified software run without creating a conflict.

In one embodiment, conflicts are identified and separate contexts are created for each instance of the application in order to allow multiple instances of an application to be run without conflicts. This method may involve a special application, which has associated with it definitions of the conflicts that arise when a particular application is run multiple times. In the example of an IP monitoring application, the definitions of the conflicts may include the log file and a configuration or policy file, but not the definition file as described above. In other embodiments, the definitions of the conflicts may not include the configuration or policy file. The special application may then create a separate storage space for each instance of the application in a hard drive of a computing device, and then may make copies of the log file or other conflicting files and place a copy in each separate space on the hard drive. According to this method, each instance of the application has its own copy of any conflicting files. The special application also configures the computing device such that each instance of the application can still reference each file or resource at the original location or by the original identifier, which the unmodified application is designed to reference to access the file or resource. In this instance, the reference made by the unmodified application is redirected to the location or identifier of the copied file or resource. Accordingly, each instance can run without modification and without conflicting with another instance.

Further, according to the exemplary method, non-conflicting files like the definition file are not copied and placed in the separate contexts. Instead, each instance of the application shares a single copy of the definition file. No conflict arises since it is possible for multiple instances to read the same file without conflict as long as none of the instances is changing or manipulating the file.

The concept may be extended beyond just files and may include assigning a particular processor or hardware device to each space, such that each instance of the application accesses a different hardware device and no conflicts arise when trying to use the same hardware device at the same time. The following figures provide more details on embodiments of the invention.

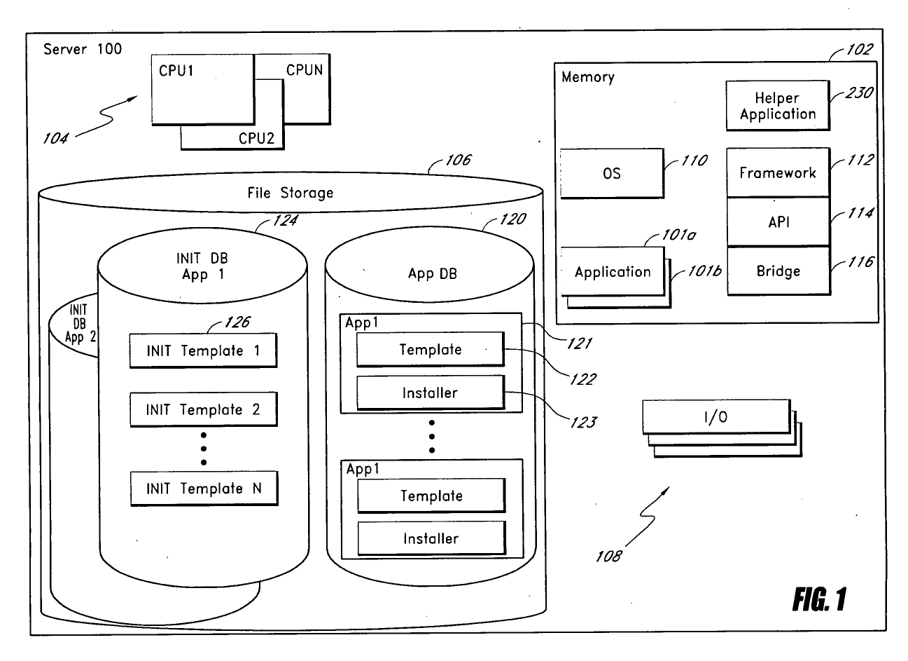

FIG. 1 is an exemplary embodiment of a computer system server 100 configured to run multiple instances of an application 101. In this embodiment, application 101 is an unmodified application not designed to run multiple instances on a single computing device. As shown, server 100 is configured to run multiple instances of an application such as application 101. The server 100 includes a memory 102, multiple processors 104, a file storage 106, and other IO devices 108 that are all shared by various applications, including application 101, designed to run on the server 100. The OS 110 and application 101 are loaded into the memory 102 and run within the memory 102. The memory 102 also contains an exemplary embodiment of a framework application 112, which facilitates running multiple instances of the application 101.

The file storage 106 in the embodiment in FIG. 1 is organized as a file system, which is accessed via the OS 110. The application 101, through the OS 110, accesses various portions of the file storage 106 by making read and/or write calls that specify a path in the file system.

In the embodiment of FIG. 1, the system includes a framework application 112, which manages creation and execution of multiple instances of the application 101. In the embodiment of FIG. 1, the framework 112 is associated with an application database 120 and an initialization database 124, which are stored on the file storage 106.

In the embodiment of FIG. 1, the application database 120 includes records for installing each instance of the application 101 to be created and executed by the framework application 112. The application database 120 is organized such that an installer 123 and a datafile, or uninitialized template 122 (e.g. XML template), are associated with each record 121. An example of one template is shown below:

```
<vp_app apptype=“ipmonitor” apptag=“DU” xml_version=“1.0”>
  <id>${ID}</id>
  <name>${NAME}</name>
  <description>Internet Protocol Network Monitor</description>
  <usage>[--cpu={cpu}][--dev={dev}][--loglevel=
  CRIT|ALERT|NONE][--debug=0|1]
  </usage>
  <!-- whether this application is enabled or not -->
  <enabled>False</enabled>
  <resources>
    <!-- System Resources -->
    <resource name=“cpu” type=“cpu” required=“no” default=“all”>
      <help>To which CPU should this process bind?</help>
    </resource>
    <resource name=“dev” required=“yes” exclusive=“yes”
    type=“etherdev”>
        <help>Which Ethernet interface shall be used for
        passivemonitoring?</help>
    </resource>
  </resources>
  <arguments>
      <!-- Application Resources -->
      <argument name=“loglevel”>
        NONE
        <help>acceptable values are CRIT, ALERT or NONE</help>
      </argument>
      <argument name=“debug”>
        0
        <help>enable debugging?</help>
      </argument>
  </arguments>
  <!-- Filesystem Mappings -->
  <!-- The following substitutions are made in the #pcdata of all entries:
    ${INSTBASE} - the instance base
    ${ID} - the ID of the new instance.
    ${name} - the value of an XML node with the given name. E.g.,
    ${cpu}
    would substitute in
the value of the resource named ‘cpu’ above.
  -->
  <maps>
    <fs_map name=“etcipmon” creation_policy=“copy”
    map_type=“DIR”>
      <src>${INSTBASE}/${ID}/etc/ipmon</src>
      <dest>/etc/ipmon</dest>
    </fs_map>
    <fs_map name=“varlogipmon” creation_policy=“mkdir”>
      <src>${INSTBASE}/${ID}/var/log/ipmon</src>
      <dest>/var/log/ipmon</dest>
    </fs_map>
  </maps>
  <!-- Framework Execution Commands -->
  <commands>
    <fw_cmd cmdname=“create” validargs=“cpu,dev,loglevel,debug”>
      echo “INSTBASE=${INSTBASE} ID=${ID}”
    </fw_cmd>
    <fw_cmd cmdname=“edit” validargs=“cpu,dev,loglevel,debug”>
      echo “INSTBASE=${INSTBASE} ID=${ID} edit script”
    </fw_cmd>
    <fw_cmd cmdname=“delete”></fw_cmd>
  <inst_cmd cmdname=“start” validargs=“cpu,loglevel,debug”>
      echo “start”
    </inst_cmd>
    <inst_cmd cmdname=“stop”>echo “stop”</inst_cmd>
    <inst_cmd cmdname=“shell”>
      /bin/bash --rcfile /opt/vp/etc/vp-rcfile
    </inst_cmd>
    <inst_cmd cmdname=“status”>true</inst_cmd>
  </commands>
</vp_app>
```

In particular, the exemplary template includes an ID field for identifying an application, a resources field which lists the system resources used by the application, and a file system mapping field, which specifies which files in the file system the instance of the application 101 may conflict when running multiple instances of the application 101. The uninitialized template 122 also includes a commands field, which lists various commands for instantiating and controlling an application 101. The template commands fields implementation provides a uniform interface between the framework application 112 and the application 101. It should be noted that the above template is merely an exemplary template and that one skilled in the art will recognize that the template may be of a different file format or a different structure.

In the embodiment of FIG. 1, the initialization database 124 is implemented as a plurality of databases 124 wherein a database containing configuration modules or initialized templates 126 is maintained for each application, e.g. a database with initialized templates 126 only for application 101. In another exemplary embodiment, the initialization database 124 is implemented as a single database including multiple initialized templates 126 for each application, e.g. a database with initialized templates 126 for all applications. The initialized template 126 may be similar to the uninitialized template 122, but the resources field may be further defined to include which system resources (e.g. a particular processor 104) are to be attributed to a particular instance of application 101. Further, the file system mapping field of initialized template 126 may include specific paths to where data associated with the particular instance of application 101 resides in the file storage 106. Additionally, the ID field may be set to identify the particular instance of application 101 the initialized template 126 is associated with.

In one embodiment, the server 100 facilitates the creation and execution of multiple instances of an application 101 using the components described above. In particular, the framework application 112 may be executed which includes a user interface, allowing the user to pick an application 101 to create and specify how many instances of the application 101 to execute. Based on the application 101 specified, the framework application 112 may then access the file storage 106 through the OS 110. Specifically, the framework application 112 accesses record 121 associated with application 101. The framework application 112 executes the installer 122 and installs files necessary to run application 101 on the file storage 106. The framework application 112 then processes the uninitialized template 122, and generates an initialized template 126, for running a first instance of the application 101a and stores it in initialization database 124.

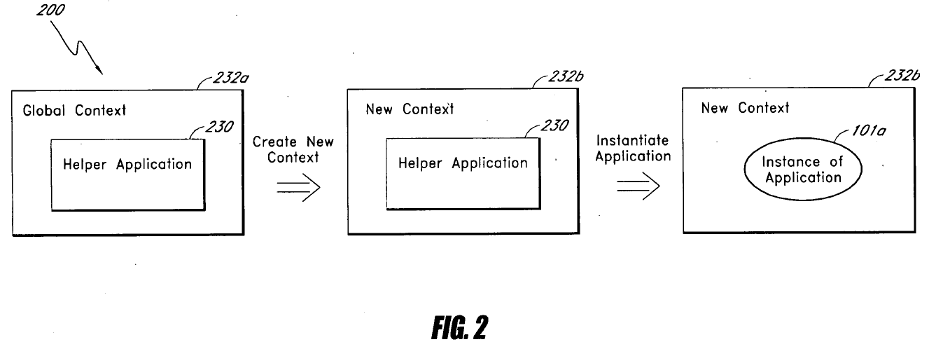

When generating the initialized template 126, the framework application 112 associates a helper application 230 with the initialized template 126, and the helper application 230 runs on the OS like any other application. The structure and environments of helper application 230 is described below with respect to FIG. 2. In one embodiment, helper application 230 resides in memory 102 of FIG. 1. This helper application 230, which ultimately can become a first running instance of the application 101a, has associated with it a context 232 created by the OS 110. When run, the helper application 230 is started in the same global context 232a that applications are started in by default. The framework application 112 also assigns a universally-unique identifier (UUID) to the helper application 230. The UUID is used to unambiguously identify an initialized template 126 to help the framework application 112 locate the context 232 of the helper application 230. It is known in the art that each context may be associated with a particular namespace which defines the file system an application in that context uses to access files in the file storage. A namespace provides identifiers (i.e. names) for the items associated with it which allows disambiguation of items having the same name (residing in different namespaces). An application's context is the virtual environment or set of data and resources that an application uses when running. This context 232 is like an environment in which the helper application 230 runs. It is known in the art that contexts are implemented by the OS 110, which allows inheritance of a context between a “parent” and a “child” process. For instance, when a first process uses OS 110 to create another process, the new process (child) may inherit the context of the first process (parent). A running instance of helper application 230 is an example of a process. Those skilled in the art will recognize a context may include environment variables, scheduler affinities, file system namespaces, signal masks, process resource utilization limits, etc, that are implemented within the kernel or libraries of OS 110 as inherited characteristics of a process. Additional inherited capabilities may be implemented within the kernel of OS 110 and system libraries to extend the inheritance of a process. One of ordinary skill in the art will recognize that the OS 110 features used for creation of contexts allow for a context to be inherited by a process that replaces an existing process (e.g., “exec” function provided by POSIX-compliant operating systems). In some cases, applications may share the same context when running. In other cases applications may each run in their own specially defined context. These specially defined contexts may overlap with other contexts (e.g. some files and/or system resources may be accessible in all contexts and other files may only be accessible by a particular context). The framework application 112 then goes on to update the ID field of the initialized template 126 with the UUID associated with the helper application 230. Accordingly the system 100 is configured to run a first instance of the application 101a.

In the above embodiment, the first instance of the application 101a is started through the framework application 112 after the initial configuration procedure described above. The user may select to start a particular instance of an application 101 by selecting the UUID of found in the initialized template 126 which defines the first instance of the application 101a. The framework application 112 performs some administrative duties with regards to associating files and system resources defined in initialized template 126 with the context 232 of the helper application 230 as described below. The following is a description of one embodiment of the execution of helper application 230 with respect to FIG. 2. The framework application 112 runs the helper application 230, and provides to the helper application 230 instructions allowing the helper application 230 to request a new context 232b from the operating system 110. Further, framework application 112 provides definitions from the initialized template 126 to the helper application 230 so it may perform initial modifications to the context 232b in preparation for execution of application 101a, and so it may execute the application 101a. Context information may be passed from the framework application 112 to the helper application 230 by standard interfaces provided by the operating system 110, including, but not limited to, environment variables, command line arguments or methods known as inter-process communication (IPC). By so passing information to the helper application 230, the framework application 112 has access to information for referencing the context 232 of helper application 230, which in turn becomes the context 232 of application 101a, and of the application-specific requirements for resolving resource conflicts. In one embodiment the framework application 112 does not contain the instructions used to create a new context and the helper application does not contain application-specific information. In this embodiment, the helper application 230 contains instructions to create contexts within the OS 110. In this manner, a helper application 230 can contain instructions for creating contexts in one or more operating systems 110. In another embodiment, there are several different helper application 230 each containing instructions to create a context within a different operating system 110. The helper application 230 instructs the OS 110 to create a separate context 232b for the helper application 230. The helper application 230 then starts the first instance of the application 101a in the separate context 232b of the helper application 230, using the information provided by the framework application 112 to the helper application 230. The helper application 230 uses standard operating system methods for replacing the current application image with another. Those skilled in the art will recognize this as an “exec” function of a POSIX-compliant operating system, or an equivalent function. Accordingly, a first instance of an application 101a is started within a context 232b inherited from the helper application 230, separate from the global context 232a that applications are started in by default.

In the embodiment of FIG. 1, server 100 includes a series of processors 104. It should be noted, however, that server 100 may include fewer or more processors. Additionally each processor may be on an individual chip, such as a multi-core processing chip, and/or may be separate chips for each processor. Further, server 100 may include multiple file storages. It should be noted that server 100 may not include a file storage 106, and instead file storage 106 may be located external to server 100. The file storage may be a flash drive, hard disk drive, solid-state drive, optical media, tape medium, and/or other storage medium. Server 100 may also include fewer or more IO devices. Memory 102 is described as a RAM, but could also be implemented as a hard drive, ROM, or other device. Memory 102 may also include additional applications or operating systems. Server 100 may also include multiple memories. Further, server 100 may include other components not described herein such as a floppy-disk drive or display device.

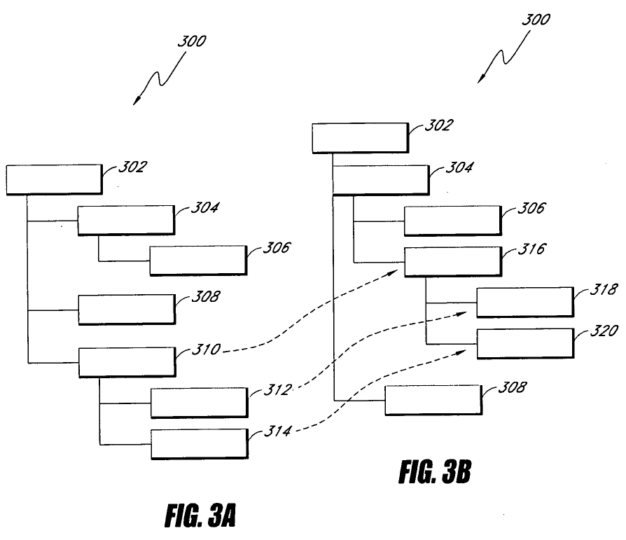

FIG. 3 is an exemplary embodiment of a global file system 300. FIG. 3a represents the file system including certain files and directories 302-314, while FIG. 3b represents the file system also including additional files and directories 316-320. Files and directories 310-314 are not shown in FIG. 3b, but in some embodiments may still be included in the file system 300. In an exemplary embodiment, the file system is implemented as a nested tree of directories and files 300 as shown in FIG. 3. There is a root directory 302, which may include sub-directories and files 304-320. Each sub-directory may further include more files and directories and the file system may continue in this nested fashion, e.g., sub-directory 304 includes a file 306.

In the embodiment of FIG. 3, the file system is described as a nested tree. However, it should be noted that the file system may be organized in a different manner such as a relational database or linked-list.

In one embodiment, the file system is organized as a global file system 300. In an exemplary embodiment, the global file system 300 is accessible by any application via the OS 110. A typical application is coded to access files, e.g. 312 and 314, within the global file system 300. The global file system 300 can include all the directories, sub-directories, and files located on the file storage 106. Further, the global file system may have the top-most directory 302, a directory that is not contained in any other directory, as the root directory 302, where any path specified to access the file system 300 begins at the root directory. The global file system may be accessed using a global namespace. When using the global namespace, calls to access a path are defined as starting at the root directory 302 of the global file system 300 and traversing the path from that point.

In an exemplary embodiment, an application is typically designed to read and write to specific paths in the global file system 300 as it executes. An application or user of an application expects certain data to be contained in the specified path when sending such a read or write command. Running multiple instances of an application can, therefore, cause conflicts when instances access the same area of the file system 300. For example, when one instance of the program writes to a particular path in the file system 312, and a second instance of the program then tries to read from that same path 312, a conflict can occur. In this case, the second instance reads the newly written information, when, instead, the information contained at the path 312 before the write command was executed is expected.

One embodiment of the system for running multiple instances of an application is configured to run without such conflicts. Applications may use certain system resources (e.g. network ports, network interfaces 108, shared memory 102, file storage 106). Further applications may have certain constant data (e.g. dynamic linked libraries) that does not change upon each use of the application and non-constant data (e.g. configuration files, log files, runtime directories), which is changed when the application is executed. Conflicts as described above arise when multiple instances of a given application try to access the same non-constant data or system resources (i.e. modules).

In the embodiment of FIG. 1, the server 100 is configured to run multiple instances of software programs. For example, each user on the server 100 may be provided with their own instance of a managed service, such as anti-spam, anti-virus, IP monitoring application or other such software.

In an embodiment of the system, the global file system 300 is also accessible in part through at least one private namespace. In an exemplary embodiment, each instance of an application is associated with a particular private namespace, which gives it access to portions of the global file system 300. In the private namespace, a call to a particular path may point to a different location of the global file system 300 than a call to the same path using the global namespace. For example a global namespace call to a particular path may be interpreted as a call to location 312 in FIG. 3a, while a private namespace call to the particular path may be interpreted as a call to location 318 as in FIG. 3b. Other calls to a path in the global file system 300 may be left unchanged between the global namespace and the private namespace, such as a call to another path may lead to location 304 in both instances. The process of causing calls to a particular path using a private namespace to point to a different location in the file system 300 than the same call using the global namespace is called remapping. In another embodiment, the private namespace can also be defined to reinterpret calls to other system resources (e.g. network interfaces 108, processors 104, etc.).

Private namespaces are defined at an OS level. Therefore, when utilizing a private namespace, the application instantly looks to the new path, as opposed to, for example, running a background application in conjunction with the running application that constantly monitors file system and system calls and redirects them as they are made. In one embodiment, the new path, e.g. 316, includes a copy of the original sub-directories and files located in the original path, e.g. 310.

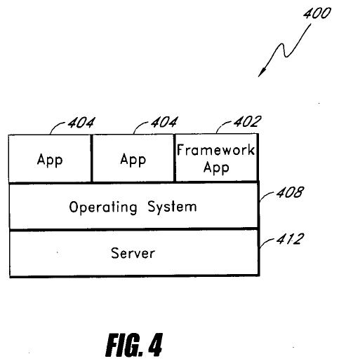

In the embodiment of FIG. 4, the system for running the framework application 402 is shown as a stack of resources 400. The framework application 402, like other applications 404, runs on top of an operating system 408 (e.g. Linux, Unix, Microsoft Windows, OS X, etc.) which runs on top of some hardware 412 (e.g. server, personal computer).

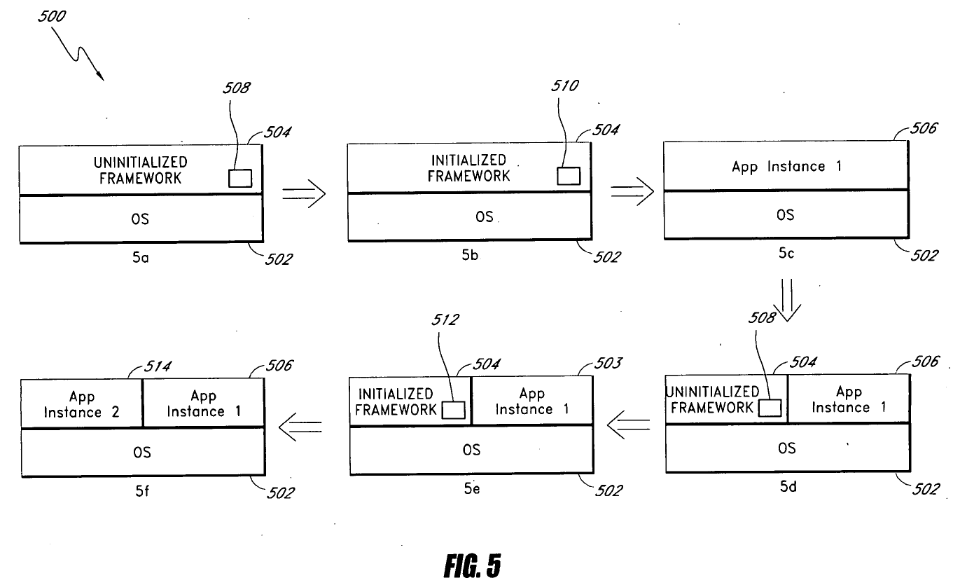

In FIG. 5, the operation of the framework application 504 is shown as a stack of resources 500 changing during the execution of the framework application 504. FIG. 5 shows how multiple instances of an application are started. The system works by first executing the operation module or framework application 504. A particular application is then selected. The framework application 504 accesses the application database and accesses the installer and uninitialized template 508 for the particular application. The framework application 504 then creates an initialized template 510 for the application. Using the initialized template 510, the loader program or framework application 504 then installs the application and remaps the system resources and file system calls to the locations specified in the initialized template 510. A first instance 506 of the application is now running. The framework application 504 can be called again and the steps repeated to initiate a second instance 514 of the application. The various steps and how they are implemented are described in more detail below.

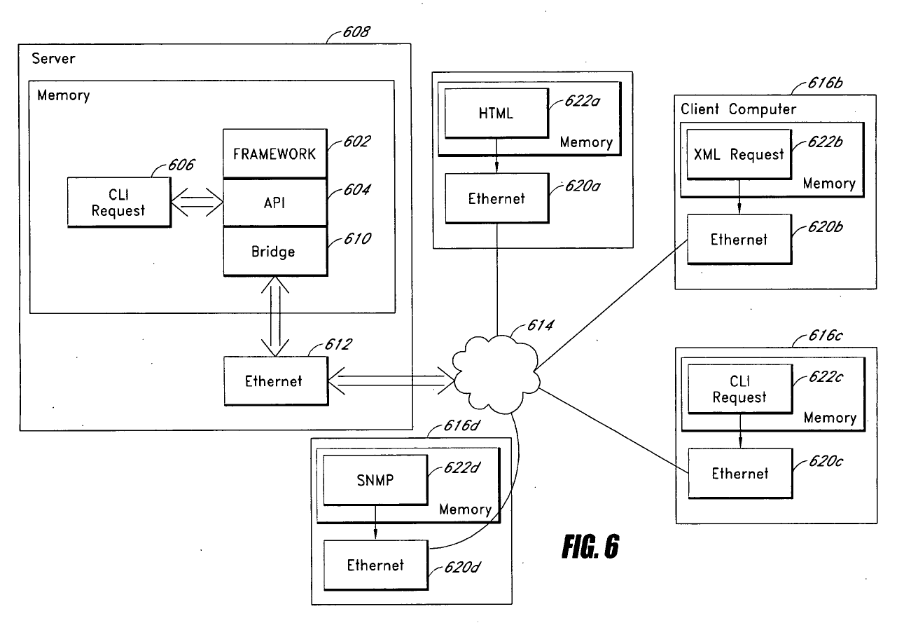

In the embodiment of FIG. 6, a framework application 602 is controlled by various interfaces. In this embodiment, the framework application 602 runs on top of an implementation of an application programming interface 604 (API), which supports requests to execute commands in the framework application 602. The API 604 may be directly accessed by receiving a command line interface request 606 (CLI) via the server 608, or remotely through a bridge 610 to network device 612. The bridge 610 accepts commands in various formats and converts them to a format compatible with the API 604. In one embodiment, the bridge 610 receives such commands through the network interface device 612 on the server 608 which connects the server 608 to a network 614 (e.g. LAN, Internet, etc.).

The network 614 may include various computers 616. Any of these computers 616 may send command requests 622a-d through a network interface device 620a-d, across the network 614, to the network interface device 612 of the server 608. In some embodiments, command requests may be generated using a web browser. The command may come in a particular format (e.g. XML-RPC, HTML, SMTP, SNMP, etc.) to the bridge 610. The bridge 610 formats the command to send to the API 604, which then in turn sends the command to the framework application 602. The framework application 602 then executes the request according to the command. The framework application 602 responds to various commands such as: instantiate a template, which generates an initialized template; start instance, which takes the initialized template and actually starts an instance of the application and remaps the file system and system calls; stop instance, which stops a running instance; and delete instance, which stops a running instance of an application and removes its files from the file system.

It should be noted that server 608 may include fewer or additional components. Further, the memory may comprise a RAM, ROM, flash disk, etc. Though, FIG. 6 shows four computers 616a-d connected to the network 614, there may be more or fewer devices 616. Additionally, though each computer 616 is shown using only one command format, each computing device 616 may also use multiple formats including additional formats not shown in the figure. In another embodiment, each computer 616 may be connected to other devices and be used as a bridge to send commands over the network 614. Further, the stack as shown of bridge 610, API 604, and framework application 602, may include more or fewer components and may receive and send communications at different levels of the stack than shown.

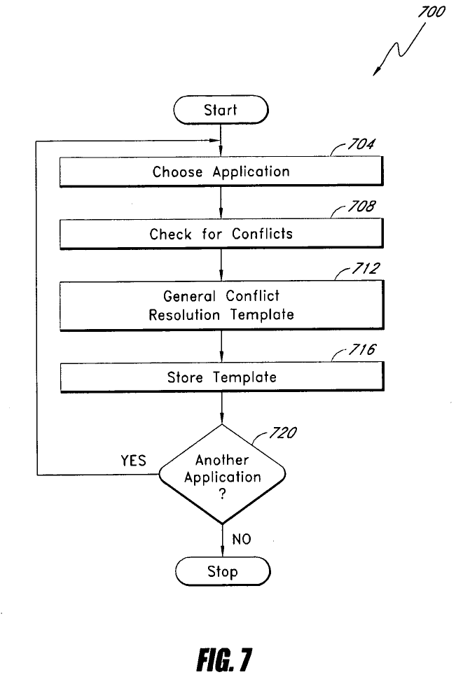

FIG. 7 illustrates a process 700 of creating an uninitialized template. The process 700 starts at a step 704 comprising choosing an application. At this step, the user chooses which application to initialize in the system. Once the application has been chosen at step 704, the process 700 moves to step 708 wherein any conflicts are discovered that would arise when running multiple instances of an application. Conflicts can be discovered by identifying system resources and non-constant data that the application accesses when running. Conflicts may arise in the file system, with IO devices, with network cards, and with CPU utilization in a system with multiple processors or processors with multiple cores. After the conflicts are identified the process 700 moves to step 712 wherein the uninitialized template is generated and the descriptions of the conflicts as well as the temporary partial file system resolution paths are written to the template. In addition to the description of the conflicts, optionally, a description of any other instance-specific data requiring user input at the stage where the instance of the application is instantiated is also written to the uninitialized template. The uninitialized template is created either automatically by a template generation program, or the template generation program may require user input. The template generation program is used to create a new file with the fields described with regards to uninitialized template 122 of FIG. 1. The fields are populated with the information gathered in step 704 identifying the application and the information gathered in step 708 identifying the conflicts. Specifically, the file system mapping field and the resources field are populated with such information.

Following creation of the uninitialized template, the process 700 moves to a step 716 wherein the uninitialized template is stored in the application database and associated with an installer application. In addition, the template can be associated with other files necessary for running the application for which the uninitialized template was generated. In a decision step 720, a decision is made whether or not another application needs to have a template created. If another application does need a template, then the process 700 returns to step 704. If no additional templates are required, the process terminates.

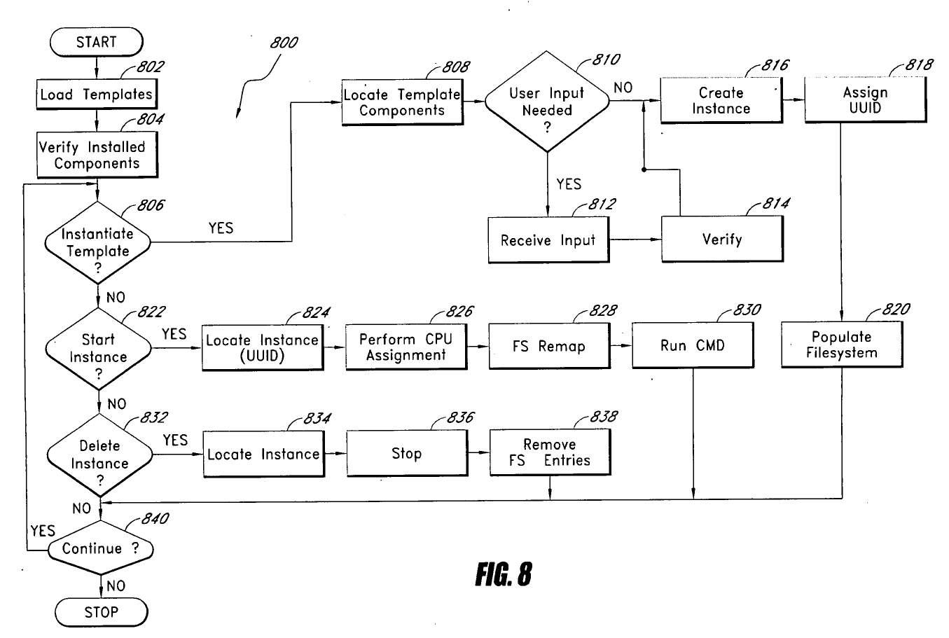

FIG. 8 illustrates a process 800 of executing a framework application. The process 800 starts at a step 802 comprising loading an uninitialized template for a particular application to be run into memory. Once the uninitialized template has been loaded at step 802, the process 800 moves to step 804 wherein the framework application verifies the installed components of the application to be run.

Following verification of the installed components, the process 800 moves to a step 806, wherein a decision is made whether or not to instantiate a template. If the decision is answered yes, the process 800 continues to next step 808. In step 808, the uninitialized template is located within the application database. Once the uninitialized template has been located, the process 800 continues to step 810 wherein it is determined whether user input is needed to create an instance of the application. User input may be needed to specify where the user wants the application installed, which processor the user wants the application to use, etc. In one embodiment user input is entered using an input device. In another embodiment, user input is entered through interfaces such as those described with respect to FIG. 6. If at step 810 it is determined user input is required, the process 800 proceeds to step 812 wherein the framework application waits for input. After receiving input, the process 800 continues to step 814, wherein the framework application verifies the input received at step 812. The process 800 then continues to step 816. If it is determined at step 810 that no user input is needed, then the process 800 continues directly to step 816. In step 816, an initialized template or configuration module is created, which includes a list of non-constant data and system resources utilized by the application and a set of resolved paths where the application calls to non-constant data and system resources are remapped or redirected to. The resolved paths are either automatically chosen by the system so as not to conflict with other initialized templates and instances of applications, or are chosen according to the user input received at step 812. Therefore, each resolved path is unique to each instance of an application. Further at step 816, a helper application is started and requests a new context to run within from the operating system utilizing the initialized template settings. After the creation of the helper application, the process 800 moves to step 818, wherein the helper application is assigned a UUID, which uniquely identifies the context in which the helper application is running. Subsequent to the assignment of the UUID, process 800 continues to step 820, wherein the global file system 200 is populated with the files necessary for the application to function. In one embodiment, the global file system 200 is populated using the installer for the application. In this embodiment, the data files for the application are installed according to the resolved paths contained in the initialized template, and/or from within the context created for the helper application from data contained in the initialized template. Once the file system has been populated, the process 800 proceeds to a decision step 840 where the process 800 can be continued or stopped. If the decision is made to continue, the process 800 returns to step 806. If the decision is made not to continue, the process 800 terminates. On the other hand, if at step 806 the decision is made not to instantiate a template, the process 800 continues to step 822.

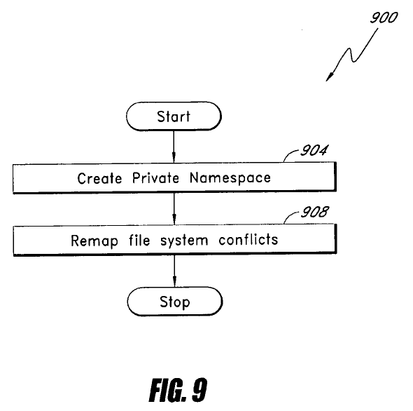

In step 822, the decision is made whether to start an instance of an application. If the decision is answered yes, the start an instance of an application command causes the framework to start a fully functional instance of an application. In one embodiment, there exists a helper application that was associated at step 816 with the application of which an instance is being started. If the decision is made to start an instance of an application in step 822 the process 800 proceeds to step 824 wherein the framework application locates the helper application using the UUID of the helper application. After locating the helper application, process 800 continues to step 826 wherein the helper application assigns the instance of the application to one or more processors according to initialized template. Subsequent to the processor assignment, process 800 moves to step 828 wherein the helper application remaps the file system and resolves system resource conflicts, which is described in more detail with respect to FIG. 9 below. Following the remapping of the file system and resolution of system resource conflicts, process 800 continues to step 830 wherein an instance of the application is executed. In one embodiment, the helper application is destroyed upon execution of the instance of the application, which executes using the context established by the helper application. In this embodiment, the instance of the application has the same UUID as now destroyed helper application. In another embodiment, the helper application remains running in the same context as the application. In this embodiment, the helper application and instance of the application have the same context and accordingly the same UUID. Once the application is executed, the process 800 moves to the decision step 840 where the process 800 can be continued or stopped. If the decision is made to continue the process 800 returns to step 806. If the decision is made not to continue, the process 800 ends. On the other hand, if the decision is made not to instantiate a template at step 806, the process 800 continues to step 832.

In step 832, the decision is made whether to delete an instance of an application. If the decision is made to delete an instance of an application, process 800 moves to step 834 where the instance of the application is located by its UUID. In an exemplary implementation, the framework application records the operating system process ID (PID) of the helper application. This mapping between PID and UUID is used to subsequently locate the helper application and descendent process or processes comprising the application instance. The process 800, after locating the application, continues to step 836 wherein the application is stopped from running in the memory. Subsequent to stopping the application, the process 800 proceeds to step 838 where file system entries associated with the instance of the application are removed. In one embodiment, only the non-constant data of the instance of the application is removed from the file system if other instances of the application exist. In another embodiment, if no other instance of the application exists, all the data associated with the application may be removed from the file system. Any virtual system resources associated with the instance of the application may also be de-allocated or removed from the system. The process 800 then continues to step 840, where the decision is made to continue the process or stop the process. If the decision is made to continue the process 800 returns to step 806. If the decision is made not to continue, the process 800 ends.

FIG. 9 describes an embodiment of step 828 of remapping the file system from FIG. 8. The process 900 of remapping the file system begins at step 904 wherein a private file system namespace is created for the instance of the application and associated with the context of the instance of the application. In one embodiment the private namespace is created by a helper application of the framework application. The helper application here acts as an initialization module. After creation of the private namespace, process 900 continues to step 908 wherein the helper application adjusts the private namespace of the instance of the application so calls to non-constant data refer to the resolved path 316 as shown in FIG. 3b instead of the original path 310 as show in FIG. 3a. The helper application here acts as a remapping module. Further in step 908, the helper application also resolves system resource conflicts by adjusting the private namespace so calls to system resources refer to free actual or virtual system resources instead of system resources already in use. The instance of the application, therefore, has access via a well-known identifier defined in the original unmodified application, such as a filesystem path name, to its own unique copy of non-constant data as well as access to free system resources so that it does not conflict with other applications or other instances of the same application. The process 900 ends after step 908 is completed.

While the above processes 700, 800, and 900 are described in the detailed description as including certain steps and are described in a particular order, it should be recognized that these processes may include additional steps or may omit some of the steps described. Further, each of the steps of the processes does not necessarily need to be performed in the order it is described. For example, step 826 of process 800 may be omitted, or step 822 may be performed before step 806.

In this way a system is developed by which multiple instances of an application can be run while not having to recreate the entire file system and operating system for each instance of the application. Further, the framework can provide each instance of the application access to native (i.e. non-virtualized) access to system resources.

The framework application has been discussed in greatest detail with regards to remapping of the file system. However, one of ordinary skill in the art will appreciate that the framework application may also be used in a variety of other embodiments. For instance, in a computer system with multiple processors and/or multiple cores per processor, a given application may be designed to utilize only one core or one processor when running. In this scenario, the other processors remain idle and become an unused processing resource. The framework application can be configured to utilize this wasted processing resource. The framework application can, as described above, allow for running multiple instances of a given application. Further, the framework may associate each instance of the application with a particular processor or core. In this manner, a computer system with, for example, 2 processors could run two copies of a particular application, each running on its own processor and fully utilizing the system resources. This may be especially beneficial where the application is designed to manipulate large amounts of data that need not be done sequentially, yet is only designed to utilize one processor. By allowing an instance of the application to run on each processor, the manipulation of data can be done in parallel and greatly increase the speed by which the data is processed. In other embodiments, the framework may assign multiple instances of an application to a particular core, or no applications to a particular core.

As used herein, an input device can be, for example, a keyboard, rollerball, mouse, voice recognition system or other device capable of transmitting information from a user to a computer. The input device can also be a touch screen associated with the display, in which case the user responds to prompts on the display by touching the screen. The user may enter textual information through the input device such as the keyboard or the touch-screen.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A Local Area Network (LAN) or Wide Area Network (WAN) may be a corporate computing network, including access to the Internet, to which computers and computing devices comprising the system are connected. In one embodiment, the LAN conforms to the Transmission Control Protocol/Internet Protocol (TCP/IP) industry standard.

As used herein, media refers to images, sounds, video or any other multimedia type data that is entered into the system.

A microprocessor may be any conventional general purpose single- or multi-chip microprocessor such as a Pentium® processor, a Pentium® Pro processor, a 8051 processor, a MIPS® processor, a Power PC® processor, or an Alpha® processor. In addition, the microprocessor may be any conventional special purpose microprocessor such as a digital signal processor or a graphics processor. The microprocessor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system may also be written using interpreted languages such as Perl, Python or Ruby.

A web browser comprising a web browser user interface may be used to display information (such as textual and graphical information) to a user. The web browser may comprise any type of visual display capable of displaying information received via a network. Examples of web browsers include Microsoft's Internet Explorer browser, Netscape's Navigator browser, Mozilla's Firefox browser, PalmSource's Web Browser, Apple's Safari, or any other browsing or other application software capable of communicating with a network.

The invention disclosed herein may be implemented as a method, apparatus or article of manufacture using standard programming or engineering techniques to produce software, firmware, hardware, or any combination thereof The term “article of manufacture” as used herein refers to code or logic implemented in hardware or computer readable media such as optical storage devices, and volatile or non-volatile memory devices. Such hardware may include, but is not limited to, field programmable gate arrays (FPGAs), application-specific integrated circuits (ASICs), complex programmable logic devices (CPLDs), programmable logic arrays (PLAs), microprocessors, or other similar processing devices.

What is claimed is:

1. A system for providing multiple instances of an application software program, comprising:
a first computer comprising an operating system designed to run the application software program; and
a framework program running on said operating system and being configured to generate multiple contexts, wherein each context is configured to run an instance of the application software program without modification of the application, and wherein the framework program is configured to access a datafile storing configuration parameters for running multiple versions of the same software program without conflicts.

2. The system of claim 1, wherein each context comprises copies of resources that conflict when running multiple versions of the same software program.

3. The system of claim 2, wherein each instance of the application software program access the copies of resources that conflict contained in the context associated with the selected instance of the application software program.

4. The system of claim 3, wherein each instance of the application software program accesses a shared resource of the first computer.

5. The system of claim 1, wherein the multiple contexts are configured to run an instance of the application software program on the operating system.

6. The system of claim 1, wherein the first computer further comprises multiple processors.

7. The system of claim 6, wherein a first context is associated with a first processor, and a second context is associated with a second processor.

8. A server computer configured to run multiple copies of the same software program, comprising:
a datafile storing configuration parameters for running multiple versions of the same software program without conflicts;
a loader program configured to read the datafile and provide multiple software contexts based on the parameters; and
an operation module configured to run one copy of the software program in each software environment.

9. A method for running multiple copies of a program on a single operating system, comprising the steps of:
providing a datafile comprising a list of modules having conflicting module calls;
executing a loader program configured to create a copy of the modules that have conflicting module calls, create a private namespace for a copy of the program, associate the copy of the modules that have conflicting module calls with the copy of the program, and map conflicting module calls made by the copy of the program to the copy of the modules.

10. The method of claim 9, wherein conflicting module calls comprise conflicting calls to a file.

11. The method of claim 9, wherein conflicting module calls comprise conflicting calls to an IO device.

12. The method of claim 9, wherein conflicting module calls comprise conflicting requests to a processor.

13. A method for running multiple copies of a program on a single operating system, comprising the steps of:
determining which modules having conflicting module calls;
executing a loader program configured to create a copy of the modules that that have conflicting module calls, create a private namespace for a copy of the program comprising the copy of the modules, associate the copy of the modules that have conflicting module calls with the copy of the program, map conflicting module calls made by the copy of the program to the copy of the modules.

14. The method of claim 13, wherein conflicting module calls comprise conflicting calls to a file.

15. The method of claim 13, wherein conflicting module calls comprise conflicting calls to an IO device.

16. The method of claim 13, wherein conflicting module calls comprise conflicting requests to a processor.

17. A system for providing multiple instances of an application software program, comprising:
a configuration module comprising a list of conflicting system module calls;
an initialization module configured to create a private file system;
a mapping module configured to map conflicting system module calls to private file system calls.
